(19) United States
(12) Patent Application Publication
(10) Pub. No.: US 2004/0157066 A1
(43) Pub. Date: Aug. 12, 2004

(54) METHOD OF APPLYING A HARDCOATING TYPICALLY PROVIDED ON DOWNHOLE TOOLS, AND A SYSTEM AND APPARATUS HAVING SUCH A HARDCOATING

(76) Inventor: G. Alexis Arzoumanidis, Houston, TX (US)

Correspondence Address: SCHLUMBERGER OILFIELD SERVICES, 200 GILLINGHAM LANE, MD 200-9, SUGAR LAND, TX, 77478, US

(21) Appl. No.: 10/248,682

(22) Filed: Feb. 7, 2003

(51) Int. Cl. B05D 1/36; B32B 9/00

(52) U.S. Cl. 428/472; 427/446; 427/402; 428/698

(57) ABSTRACT

A protective hardcoating system is provided for a metallic substrate of a downhole tool. The metallic substrate is generally characterized by a thermal coefficient. The hardcoating system includes a hardface coating that is applied onto the substrate to protect it against wear. The hardface coating includes an interface section positioned adjacent to the substrate and defining an interface therewith, and a hard surface section positioned externally of the interface section. Further, the hard surface section includes an exposed surface. In this hardcoating system, the interface section and the surface section have a composition including a predetermined hardness component constituency and a thermal coefficient at least partially attributable to the hardness component constituency. The hardness component constituency of the interface section is distinct from the hardness component constituency of the hard surface section such that the difference between the thermal coefficient of the interface section and the thermal coefficient of the substrate is substantially less than the difference between the thermal coefficient of the substrate and the thermal coefficient of the surface section.

### BACKGROUND OF INVENTION

The present invention relates generally to a system and method for providing or applying a protective hardcoating on a machine or tool element that is otherwise subjected to excessive wear during service. The invention also relates generally to such a machine or tool element having the protective hardcoating. The system and method for applying the hardcoating according to the invention are particularly adapted for use with downhole tools, such as drill bits, tool joints, stabilizers, drill collars and the like, and metal bearings, and other tools and machine elements which require protection against excessive wear.

During operation, downhole tools often encounter extreme conditions, including high heat, high pressure, vibration, and impact. These tools are also subjected to contact with abrasive formations, erosive fluids, frictional contact with other tool elements, and other sources of wear. To protect against these conditions, particularly excessive wear, various elements of the downhole tools are provided with a welded metal hardfacing or hardface coating. These hardface coatings provide hardness to the exterior of the tool elements, particularly the surfaces which come in contact with the abrasive formations. The required hardness is often accomplished by providing a coating composed of tungsten carbide particles which are cemented in place by a metal binder. The matrix formed by the carbide particles and the binder is applied as a coating to the various surfaces. Alternatively, a uniform coating of a hard material may be provided.

### SUMMARY OF INVENTION

The present invention provides an improved coating system and coating method, which are particularly adapted for use with or on downhole tools and other machine and tool elements. The invention also relates to a machine or tool element having such a coating. The coating system, method and tool according to the invention provides a means for alleviating or preventing interfacial cracking and other deficiencies occurring or originating at or near the interface of the coating and the tool.

A protective hardcoating system according to the invention is adapted for use with a metallic substrate. The metallic substrate is generally characterized by a thermal coefficient of expansion (or other mechanical or chemical property identified as a factor in the promotion of interfacial failures near the interface of the coating and the substrate). The system includes a hardface coating that is applied onto the substrate to protect it against wear. This coating includes an interface section positioned adjacent to the substrate and defining an interface therewith, and a hard surface section positioned externally of the interface section. Each of the interface section and the surface section has a composition that includes a predetermined hardness component constituency and a thermal coefficient of expansion (or other mechanical/chemical property) that is at least partially attributable to the hardness component constituency. The hardness component constituency of the interface section is distinct from the hardness component constituency of the hard surface section such that the difference between the thermal coefficient (or other mechanical/chemical property) of the interface section and the thermal coefficient of the substrate is substantially less than the difference between the thermal coefficient of the substrate and the thermal coefficient of the surface section. Such a protective hardcoating system is particularly adapted for downhole tool applications.

Preferably, the hardness component constituency is provided by hard metal particles such as tungsten carbide particles supported or interspersed within a metal binder. In alternative embodiments, the hardness component may take the form of other hard metal particles, ceramic particles, poly crystalline diamond particles, or other components known capable of imparting hardness to the coating.

In yet another embodiment, the hardcoating includes multiple layers or overlays, the interface section including at least a first overlay and the surface section including at least the last overlay. In this embodiment, the first overlay is preferably populated with substantially less of the hardness component than the last overlay (e.g., less than about 50% of the population of carbide in the last overlay, and more preferably about 30-40%). In a further embodiment utilizing an intermediate overlay, the intermediate overlay is preferably populated with about 60-80% of the population of hardness component in the last overlay.

The invention is also directed to a machine or tool element equipped with the hardcoating as described above. The inventive downhole tool comprises a tool element including a metallic substrate and a hardface coating applied onto the substrate (for protection of the substrate against wear). In one embodiment, the hardface coating has multiple welded overlays including an interface overlay interfacing the substrate and defining an interface therewith, a hard surface overlay positioned externally of the interface overlay and including an exposed surface, and at least an intermediate overlay positioned between the interface overlay and the hard surface overlay. The coating is characterized by a hardness component constituent gradient: the gradient providing a smaller concentrations of hardness component in and near the interface section and greater concentrations of the hardness component in or near the hard surface overlay. As such, the thermal coefficient of the coating generally increases from the exposed surface to the interface. Thus, the difference in the thermal coefficient of the interface overlay and the thermal coefficient of the substrate is substantially less than the difference between the thermal coefficient of the substrate and the thermal coefficient of the surface overlay.

In another aspect of the invention, a method is provided for applying a welded protective hardface coating on a machine element, downhole tool element, and the like, so as to protect the element from wear during operation. The method includes selecting a metallic substrate of the machine or tool element for application of the coating, and applying a first welded layer over the substrate. The welded layer is characterized by a matrix of hardness particles interspersed in a metal binder and a thermal coefficient of expansion. Next, at least one intermediate overlay is applied after the first overlay, the intermediate overlay being also composed of a matrix of hardness particles interspersed within a metal binder and characterized by a thermal coefficient of expansion. A last overlay is then applied after (but necessarily adjacent) the intermediate overlay. This last overlay is also composed of hardness particles interspersed within a metal binder and has a hardness that is substantially greater than the hardness of the first overlay and a thermal coefficient of expansion that is substantially less than the thermal coefficient of the first overlay. Moreover, the method provides that the difference between the thermal coefficient of the substrate and the thermal coefficient of the first overlay is substantially less than the difference between the thermal coefficient of the last overlay and the thermal coefficient of the substrate and, further, that the intermediate overlay has a thermal coefficient that is less than the thermal coefficient of the first overlay and greater than the thermal coefficient of the last overlay.

In yet another aspect of the invention, a method is provided for thermally spraying a uniformly sized coating. In the spraying process, the sprayed materials are initially identical to the substrate, but as the process continues, the spray provides increasing amounts of a hardness component or hardfacing material, until the outer surface is essentially hardfacing material. Such a uniform, hard spray coating could use nanocrystalline or amorphous metals as the hardfacing material.

These and other objects, features, and advantages of the present invention will become apparent to those skilled in the relevant art from the following detailed description of one or more preferred embodiments and the accompanying drawings.

### BRIEF DESCRIPTION OF DRAWINGS

FIG. 1 is an illustration of an exemplary machine or tool element utilizing a coating system and apparatus according to the invention;

FIG. 2 is a micrograph illustration of a prior art hardface coating system;

FIG. 3 is a micrograph illustration of the prior art hardface coating experiencing interfacial cracking;

FIG. 4 is a simplified illustration of a hardface coating system applied to a metal substrate in accordance with the invention; and

FIG. 5 is a simplified illustration of an alternative hardface coating system according to the invention.

### DETAILED DESCRIPTION

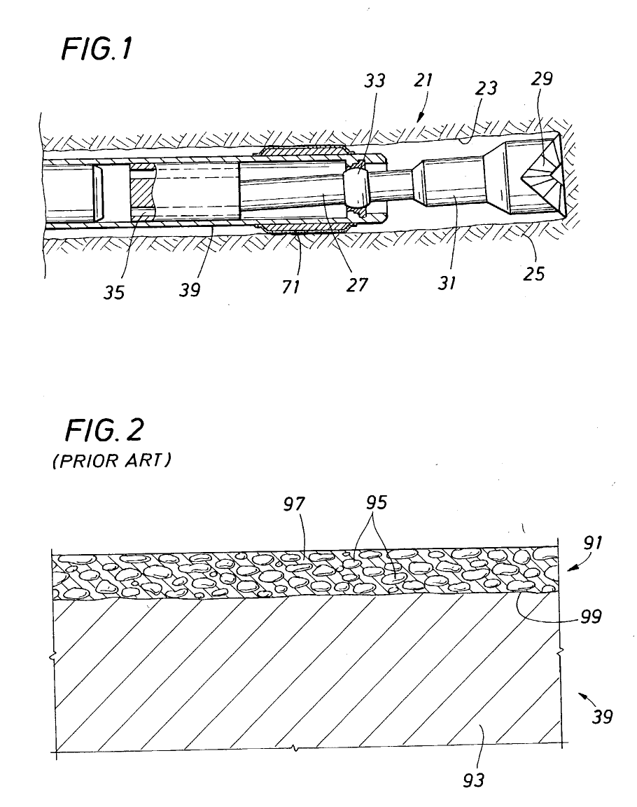

FIG. 1 depicts an exemplary downhole tool embodying various aspects of the present invention. More particularly, FIG. 1 depicts a section of a drill string assembly, generally designated 21, in various cut-outs. The drill string assembly 21 provides a mud motor used in directional drilling of a well bore 23 in a rock formation 25. The drill assembly 21 allows for a bend near the drill bit 29, so that the drilling direction may be deviated from the wellbore axis by pushing against the formation 25. The drill assembly 21 includes a bendable drive shaft 27 driving the drill bit 29. The drive shaft 27 also includes a collar 31 securing the drill bit/cutter 29. Rotation of the drive shaft 27 is facilitated by a bearing assembly 33, and fluid communication ports 35 for communicating drilling fluids to and from the front of the assembly 21. By pumping drilling fluids (mud) through the mud motor, the bit 29 turns while the drill string does not, thereby allowing the bit 29 to drill in the direction it is pointed. Further, the drill string assembly 21 includes a protective tubular jacket 39 surrounding and isolating the internal tool elements.

The drill string assembly 21 is an example of a machine or tool element particularly adapted for use with the inventive hardface coating system. As described previously, the invention has applications to other downhole tools and other machine elements, which are not described here. These and other applications of the invention will, however, become readily apparent to one skilled in the relevant mechanical, chemical or metallurgical art, upon reading the present disclosure and/or viewing the accompanying drawings.

During drilling operations, the drill string assembly 21 is subjected to a variety of extreme conditions, including abrasion, erosion, and metal-to-metal wear. Returning to FIG. 1, the bearing assembly 33 is subjected to wear due to metal-to-metal contact, fatigue, heat, and excessive fluid flow and pressure conditions. Thus, it is advantageous to coat the various bearing elements with a protective hardfacing. In other applications, a bushing assembly may be employed in lieu of the bearing assembly. The various bushing elements may also be coated according to the invention.

The orifice or communication ports 35, provide an example of components or areas of the drill string assembly 21, that may be subjected to fluid erosion. The erosive fluid or mud, often containing abrasive particles, flows through the communication ports, and subjects the port walls to erosion. Thus, the walls of the ports 35 are primary candidates for application of a protective coating according to the invention.

Finally, the tubular jacket 39, or more precisely, the external surface of the jacket usually requires some type of hardface coating to resist the abrasive forces acting on it during drilling. During drilling, the external surface rubs against and along the walls of the wellbore, and the abrasive rock formation. The abrasive forces encountered during directional drilling, particularly when the drilling assembly is turned against the rock formation, may be even more pronounced. As shown in FIG. 1, the section of the tubular jacket 39 (near or around the bend in the drive shaft 27) which typically contacts the rock formation during the turn, can be provided with a hardface coating 71 according to the invention.

The focus of the present description is on an exemplary application of the inventive protective coating as applied to a downhole tool. More particularly, the detailed description is directed to an application of the invention to the drill string assembly 21 or, even more specifically, to the tubular jacket 39 of the drill string assembly 21. As mentioned above, the inventive coating system, method, and apparatus (tool or machine element) have other applications not described herein but is contemplated to be within the scope of the invention. For example, the inventive protective coating may be applied to other elements or substrates of the drill string assembly 21. Further, the invention should not be limited to the environmental conditions against which the protective coating protects the drill string assembly 21. Reference to such conditions or use of the invention, (i.e., in the claims) is made as a suggestion only. Although the invention is particularly adapted for use as protection against the above-described abrasion, erosion and other conditions, it may also be utilized to protect against vibration, high pressure, high heat, impact, material mismatch, and other stresses. Again, for purposes of the present description, these conditions are collectively referred to herein as wear conditions against which the inventive coating system is employed.

FIG. 2 depicts a traditional or prior art hardface coating 91. The hardface coating is applied to a metal substrate 93, such as the outer surface of the tubular or mud jacket 39. The hardface coating 91 is formed by one or more welded layers of a hard metal 95, such as tungsten carbide, cemented into and within a metal binder 97 to form a steel alloy matrix. The metal binder 97 may be composed of steel alloy, e.g., Nickel-Boron alloy for non-magnetic applications. As shown in FIG. 2, the hardface coating 91 interface forms a distinct interface 99 with the surface of the substrate 93. The hard metal, e.g., tungsten carbide particles, imparts hardness to the coating, which in turn provides the desired protection against wear.

FIG. 2 also illustrates the traditional application of the prior art carbide-laden hardface coating. The prior art application provides generally uniform distribution of the carbide particles through the thickness of the hardface coating 91.

The distinct or abrupt change from the hardface coating to the substrate provides a prime area for interfacial cracking and other modes of failure. Stresses result from the differences in certain intensive mechanical or chemical properties (e.g., intensive mechanical properties such as thermal coefficient of coefficient, mechanical strength, etc.) of the two materials engaged at or otherwise forming the interface. These properties (and resulting stresses) are discussed in a paper entitled Mixed-mode Cracking in Layered Materials (Hutchinson, J. W; Z. Suo, Advances in Applied Mechanics, 29:63-191, 1992, which is hereby incorporated by references for all purposes and made a part of the present disclosure. For present purposes, these properties are collectively referred to herein as bi-material mechanical properties. The various methods and coating designs discussed herein work to reduce the differences in one or more of these mechanical properties at the bi-material interface. In particular, the relatively low thermal expansion coefficient of the carbide laden matrix leads to excessive thermal stresses at the interface 99 between the coating 91 and the substrate 99. These stresses are a direct result of the difference in the rate of thermal expansion between the substrate and the steel alloy matrix (which is governed by the thermal coefficients of expansion for the substrate and the steel alloy matrix). This difference becomes more pronounced during drilling operations when the tool is subjected to high heat, high pressure, and other extreme conditions. It has been observed that this difference in thermal expansion coefficients contributes, facilitates or otherwise promotes a flaking failure mode. In addition to compromising the abrasion resistant feature of the hardface coating, the flakes resulting from this failure can cause damage to the drill bits. One objective of the invention is to reduce the differences in the properties of the two materials forming the interface, thereby reducing the vulnerability of the coating system to interfacial failures and other failures.

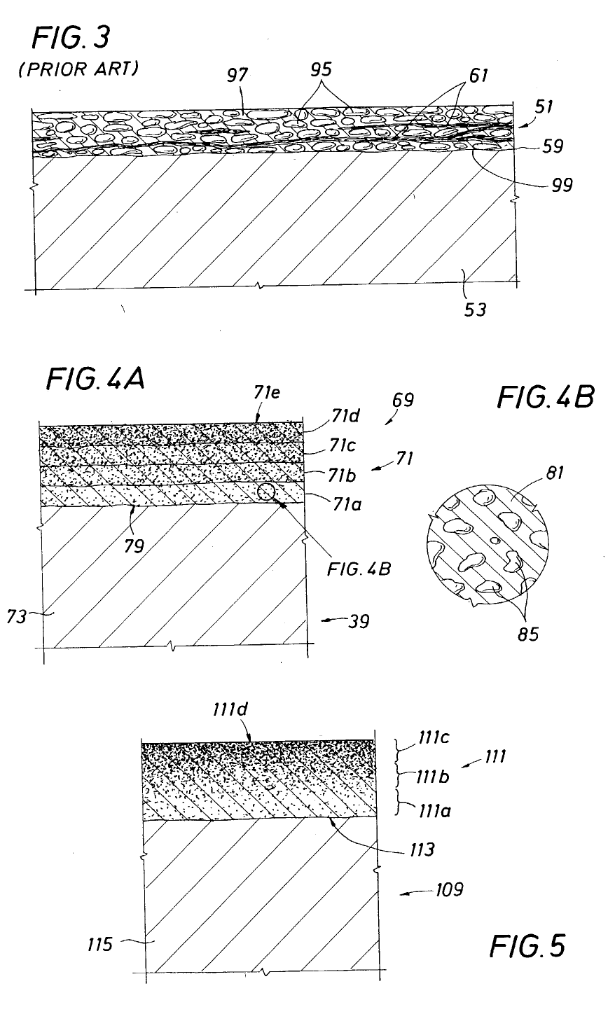

FIG. 3 illustrates the type of interfacial cracking 61 that can occur near the interface 59 between the hardface coating 51 and the substrate 53. To address the problems described above, and in particular to alleviate the thermal stresses experienced at the substrate-hardface coating interface, the present invention provides a method of applying the hardcoating such that there is a smoother transition between the hardface coating and the substrate. In other words, the interface between the hardface coating and the substrate is generally less distinct.

As used herein, the terms “hardcoating,” “hardfacing,” or “hardface coating” are synonymous. Generally, these terms are used to refer to the type of protective coating contemplated by the present invention, namely, a coating having a composition that imparts relative hardness for protection against external wear conditions. The invention is particularly directed to such a hardcoating having concentrations of hardness components. The hardness component may be in the form of hard particles such as hard metals or ceramics, contained, interspersed, or otherwise supported within a relatively ductile network (e.g., a steel alloy matrix). The hardness component may also take the form of a hardening constituent, e.g., in an amorphous or nanocrystalline metal alloy.

FIG. 4 provides a simplified illustration of one embodiment of a hardface coating system according to the invention, as applied to the tubular jacket 39 in FIG. 1. The inventive hardface coating system 69 includes a hardface coating 71 and a substrate 73 onto which the hardface coating is applied. The hardface coating 71 of FIG. 4 preferably includes a plurality of layers or overlays applied by laser welding (71a-71d). The hardface coating 71 consists of an interface section or layer 71a positioned adjacent the substrate 73 and forming an interface 79 therewith. An opposite surface layer 71d is provided with an exposed surface 71e that is adapted to withstand or contact external forces, i.e., rock formations. The hardface coating 71 further includes intermediate layers 71b, 71c. It should be noted that, in some applications, the layers, overlays, or sections of the inventive coating may not be readily, visually distinct (depending on the coating design and/or the application process). The illustration of FIG. 4 of a laser-welded coating is exaggerated so as to facilitate description.

In the coating system 69 of FIG. 4, the laser-welded layers or overlays include a hard metal constituency formed primarily of hard metal particles 85. The hard metal particles, preferably tungsten carbide, are cemented in place by a metal binder 81. The carbide particles in FIG. 3 are generally of the same size throughout the layers. However, in this preferred embodiment of the invention, the number of or concentration of carbide particles in the interface section or layer 71a is substantially less than the concentration or amount of carbide content in the surface section 71d. Particle size or concentration density can be adjusted to achieve this concentration difference in layers. More specifically, with each successive layer from the interface 79, the concentration of carbide particles in the layers are preferably increased. Accordingly, the last or surface section/layer 71d has the most carbide content, while the interface section or layer 71a has the smaller concentration of carbide particles. The surface section 71d is, as a result, characterized by a hardness that is significantly greater than the hardness of the layers beneath it, particularly, the first layer or interface layer 71a. In turn, the interface section 71a is characterized by a higher thermal coefficient than the surface section 71d.

In one further embodiment of the invention, the four layer configuration shown in FIG. 4, includes an interface layer 71a characterized by a carbide concentration that is less than about 50% (e.g., 30 weight percent carbide) of the carbide concentration on the surface layer (e.g., 60 weight percent carbide) 71d and more preferably, about 33% (e.g., 20 weight percent carbide). The intermediate layer 71b is characterized by a carbide concentration that is approximately 50% to 75% (e.g., 30-45 weight percent carbide) of the carbide concentration in the surface section, and more preferably about 66% (e.g., 40 weight percent carbide). The intermediate layer 71c has a carbide concentration that is preferably about the same as that in the surface layer 71d. Thus, there is a gradual increase of carbide concentration with each successive layer. The successive increase or decrease of carbide concentrations may be referred to as a gradient that corresponds with the variance of the coating's thermal coefficient as a function of thickness or distance from the interface.

The advantageous result of the illustrated configuration is a gradual increase in the thermal coefficient of the layers, with each successive layer that is closer to the interface. More specifically, the hardface coating is provided with an interface layer having a hard metal content providing thermal coefficient properties which are closer or more similar to that of the metallic substrate. Accordingly, the difference in the thermal coefficient of the interface section and that of the substrate is minimized, thereby providing a smoother transition, and reducing or eliminating the vulnerability of the interface to interfacial stresses. The coating maintains, however, the hardness properties required of it. These properties are imparted on the coating by the surface layer and the layer(s) directly beneath it.

In the coating system 69 of FIG. 4, the hardness component or constituency is preferably provided by tungsten carbide particles, but may also be silicon carbides, or ceramics such as zirconia or alumina, or even a poly crystalline diamond. The binder is preferably a steel alloy such as “Nickel-boron alloy” (and thus has a thermal coefficient generally 2-3 times higher than the tungsten carbide particles). Hardness gradient could also be achieved by mixing substrate material and uniform hardfacing material during the spray process.

As used herein, the term “hardness component constituency” shall refer generally to how much of the hardness component is found in a given layer, section, or thickness range of the coating. The constituency may be referred to in terms of concentration, density, or population, and by weight, weight percent, or volume percent. It should also be noted that, in some embodiments, it may be difficult to divide the coating in to discreet layers, sections, or overlays. In these cases, the layers, section, or overlays may drawn artificially. For example, when referring to three layers of a coating, the coating is divided into three even thickness layers.

FIG. 5 depicts such a coating 111 applied to a metallic substrate 115. The coating 111 also has an interface surface 113 and an external surface 111d, wherein the shading indicates the density of carbide particles or fraction of hardfacing material (hardness component) in spray. In this coating, the reduction or increase in carbide content is gradual, and thus the sections or layers may be visually approximated. For instance, the coating may be identified as having three sections enumerated as 111a, 111b, and 111c.

On the other hand, if three distinct sections (e.g., due to obvious distinctions in hardness component concentrations) are clearly identifiable, these three sections would make up the three sections, layers, or overlays.

In a preferred method of applying the inventive hardface coating, laser applied hardfacing techniques are used. Other welding techniques could also be utilized, such as oxyacetylene fuel. These techniques, and commercial services offering these techniques, are generally known in the industry. In a typical design, the desired carbide concentration is first determined. This concentration is that which is necessary to achieve the hardness required for good abrasion resistance. As each layer is applied to the substrate and preceding hardface coating layers, the concentration or amount of the carbide is increased by a fractional amount. In the laser applied hardfacing application, this variance or gradient is achieved by varying the amount of carbide particles that is mixed into the coating. In alternative embodiments, the type of hard metal particle may also be varied, as well as the size of the carbide particles. It should also be noted that the inventive method and system may be applied with multiple layers, including a system with only two layers. One particular advantage in utilizing smaller particles near the interface, is that the stresses within the composite coating may also be alleviated. Larger particles would be desirable near the surface section so as to optimize the abrasion resistance of the coating. Further, the external surface may be provided a combination of large and small particles to optimally fill interstices.

In an alternative method of applying the inventive hardface coating, thermal spray process, such as High Velocity Oxyacetylene Fuel, is utilized. In this method, relatively uniform (e.g., a fine mixture) mixture is sprayed onto a substrate. Tungsten carbide is directly applied with this process, as could amorphous or nanocrystalline metal. The gradient is achieved by mixing the feed into the sprayer. This mixture would have both substrate material powder and hardfacing material powder. A similar mixture could be welded on with oxyacetylene fuel.

The apparatus, systems and methods described above are particularly adapted for oil field and/or drilling applications, e.g., for protection of downhole tools. It will be apparent to one skilled in the art, however, upon reading the description and viewing the accompanying drawings, that various aspects of the inventive apparatus, systems and methods are equally applicable in other applications wherein protection of machine or tool elements is desired. Generally, the invention is applicable in any environment or design in which protection of machine or tool elements subjected to the various wear conditions described above is desired.

The foregoing description is presented for purposes of illustration and description, and is not intended to limit the invention in the form disclosed herein. Consequently, variations and modifications to the inventive hardface coating systems and methods described commensurate with the above teachings and the teachings of the relevant art are within the scope of this invention. These variations will readily suggest themselves to those skilled in the relevant oilfield, machining, and other relevant industrial art, and are encompassed within the spirit of the invention and the scope of the following claims. Moreover, the embodiments described (e.g., multiple-layered coating application on a tubular jacket of a drill string assembly) are further intended to explain the best mode for practicing the invention, and to enable others skilled in the art to utilize the invention in such, or other, embodiments, and with various modifications required by the particular applications or uses of the invention. It is intended that the appended claims be construed to include alternative embodiments to the extent that it is permitted by prior art.

What is claimed is:

1. A protective hardcoating system for a metallic substrate of a downhole tool and the like, the metallic substrate generally characterized by a thermal coefficient, said hardcoating system comprising:
a hardface coating applied onto the substrate, the hardface coating including an interface section positioned adjacent the substrate and defining an interface therewith, and
a hard surface section positioned externally of the interface section, the hard surface section including an exposed surface; and
wherein each of the interface section and the surface section has a composition including a predetermined hardness component constituency and a thermal coefficient at least partially attributable to the hardness component constituency, the hardness component constituency of the interface section being distinct from the hardness component constituency of the hard surface section such that the difference between the thermal coefficient of the interface section and the thermal coefficient of the substrate is substantially less than the difference between the thermal coefficient of the substrate and the thermal coefficient of the surface section.

2. The system of claim 1, wherein the hardface coating includes multiple overlays, the interface section including at least a first overlay and the surface section including at least a last overlay, the first overlay being generally populated with a smaller concentration of the hardness component than the last overlay.

3. The system of claim 2, wherein a concentration of the hardness component in the first overlay is less than about 50% of the concentration of the hardness component in the last overlay.

4. The system of claim 1, wherein the hardness component constituencies include a population of hard metal particles supported within a metal binder.

5. The system of claim 4, wherein the hardface coating includes concentrations of tungsten carbide interspersed in a metal binder and providing the hardness component constituencies, the surface section being substantially more densely populated with carbide than the interface section, thereby providing the interface section with a higher thermal coefficient than the surface section and the hard surface section with a hardness greater than a hardness of the interface section.

6. The system of claim 1, wherein the hardface coating includes multiple overlays, the interface section including a first overlay and the surface section including a last overlay, wherein the overlays are positioned such that each successive overlay after the first overlay has generally an equal or greater concentration of the hardness component than the preceding overlay and wherein the first overlay has a concentration of the hardness component that is less than about 50% of the concentration of the hardness component in the last overlay.

7. The system of claim 1, wherein the hardface coating includes multiple overlays, the interface section including a first overlay and the surface section including a last overlay, and wherein the first overlay has a concentration of hard metal that is less than about 40% of a concentration of hard metal in the last overlay, and an intermediate overlay positioned between the first and last overlays has a hard metal concentration that is between about 60% and 80% of the hard metal concentration of the last overlay, and wherein the hardness component constituencies includes concentrations of the hard metal.

8. The system of claim 1, wherein the hardface coating includes multiple overlays, the interface section including a first overlay and the surface section including a last overlay, and wherein the hardness component constituencies of the overlays are composed of hard metal particles, and wherein the overlays positioned closer to the exposed surface has a larger concentration of hard metal particles than overlays positioned closer to the substrate.

9. The system of claim 8, wherein the hard metal particles are tungsten carbide particles.

10. The system of claim 1, wherein the hardface coating includes multiple overlays, the interface section including a first overlay and the surface section including a last overlay, and wherein the hardness component constituencies of the overlays are composed of hard metal particles, and wherein the overlays positioned closer to the exposed surface is generally populated by larger hard metal particles than overlays positioned closer to the substrate.

11. The system of claim 1, further comprising an intermediate section positioned between the interface section and the hard surface section, the intermediate section having a composition including a predetermined hardness component constituency, each of the hardness component constituencies including a hardness components the hardness component provided in the intermediate section being different from the hardness component in the hard surface section.

12. The system of claim 1, wherein the hardness component constituencies are provided by hardness component particles selected from the group consisting of: hard metal particles including tungsten carbide parties, silicon carbide particles, ceramic particles including alumina and zirconia, poly crystalline diamond particles, and combinations thereof.

13. The system of claim 1, wherein the metallic substrate is composed of a metallic substrate material, and wherein the interface section has a composition that includes a first mixture material, the first mixture material being metallic substrate material.

14. The system of claim 13, wherein the hardface coating is generally composed of a mixture of a base material and a hardness material providing the hardness component constituency, such that the ratio of base material to hardness material generally decreases in the direction from the interface to the external surface.

15. The system of claim 14, wherein the metallic substrate is composed of a metallic substrate material, and wherein the base material is metallic substrate material.

16. A downhole tool comprising:
a tool element including a metallic substrate; and
a hardface coating applied onto the substrate, the hardface coating including multiple overlays including,
an interface overlay interfacing the substrate and defining an interface therewith,
a hard surface overlay positioned externally of the interface overlay and including an exposed surface, and
at least an intermediate overlay positioned between the interface overlay and the hard surface overlay, such that the overlays define the thickness of the coating, the coating thickness being characterized by a hardness component constituent gradient, the gradient providing a smaller concentration of hardness component in and near the interface section and a larger concentration of the hardness component in or near the hard surface overlay, such that the thermal coefficient of the coating generally increases from the external surface to the interface, and such that the difference in the thermal coefficient of the interface overlay and the thermal coefficient of the substrate is substantially less than the difference between a thermal coefficient of the substrate and the thermal coefficient of the surface overlay.

17. The downhole tool of claim 16, wherein the hardness component constituencies are provided by hardness component particles selected from the group consisting of: hard metal particles including tungsten carbide parties, silicon carbide particles, ceramic particles including alumina and zirconia, poly crystalline diamond particles, and combinations thereof.

18. The downhole tool of claim 17, wherein the hardness component constituency include tungsten carbide particles interspersed in a metal binder, the surface overlay being substantially more densely populated with carbide particles than the interface overlay, thereby providing the interface overlay with a higher thermal coefficient than the hard surface overlay and the hard surface overlay with a hardness greater than the hardness of the interface overlay.

19. The downhole tool of claim 18, wherein the concentration of carbide particles in the interface overlay is less than about 50% of the concentration of carbide particles in the hard surface overlay.

20. The downhole tool of claim 17, wherein the interface overlay has a concentration of hard metal particles that is less than about 50% of the concentration of hard metal particles in the hard surface overlay, and the intermediate overlay has a concentration of hard metal particles that is between about 60% and 80% of the concentration of hard metal particles in the hard surface overlay.

21. The downhole tool of claim 16, wherein the hardness component constituencies of the overlays are provided by hard metal particles, and wherein the overlays positioned closer to the exposed surface has a larger concentration of hard metal particles than overlays positioned closer to the substrate.

22. The downhole tool of claim 16, wherein the hardness component constituencies of the overlays are provided by hardness particles, and wherein the overlays positioned closer to the exposed surface is generally populated by larger particles than overlays positioned closer to the substrate.

23. The downhole tool of claim 16, wherein the coating has a mixture composition including the hardness component constituency and a first mixture material, the hardness component constituency of the coating being generally increased relative to the first mixture material in the direction from the interface to the external surface.

24. The downhole tool of claim 23, wherein the hardness component constituency of at least the hard surface overlay is provided by a hardness component selected from the group consisting of: hard metal particles, ceramic particles, amorphous metals, nanocrystalline metals, polycrystalline diamond parties, silicon carbide particles, and combinations thereof.

25. A method of applying a protective hardface coating on a downhole tool element and the like, so as to protect the element from wear during operation, the method comprising the steps of:
selecting a metallic substrate of the downhole tool element and the like, for application of the coating;
applying a first overlay over the substrate, the first overlay being composed of a hardness component constituency and a metal base material and characterized by a thermal coefficient of expansion;
applying at least one intermediate overlay after the first overlay, the intermediate overlay being composed of a hardness component constituency and a metal base material and characterized by a thermal coefficient of expansion; and
applying a last overlay after the intermediate overlay, the last overlay being composed of a hardness component constituency and a metal base material, whereby the last overlay has a hardness that is substantially greater than the hardness of the first overlay and a thermal coefficient of expansion that is less than the thermal coefficient of the first overlay, such that the difference between the thermal coefficient of the substrate and the thermal coefficient of the first overlay is substantially less than the difference between the thermal coefficient of the last overlay and the thermal coefficient of the substrate and whereby the intermediate overlay has a thermal coefficient that is less than the thermal coefficient of the first overlay and greater than the thermal coefficient of the last overlay.

26. The method of claim 25, wherein the steps of applying a first overlay, intermediate overlay, and a last overlay, include providing hardness particles as the hardness component constituency and supporting the hardness particles within the base material providing successively more hardness particles within the base material for each successive overlay after the first overlay.

27. The method of claim 25, wherein the steps of applying a first overlay, intermediate overlay, and a last overlay, include applying tungsten carbide particles as the hard metal particles.

28. The method of claim 25, wherein the steps of applying a first overlay, intermediate overlay, and a last overlay, include welding the overlays.

29. The method of claim 25, wherein the steps of applying a first overlay and applying the last overlay, include providing a first overlay having a hard metal concentration that is less than about 50% of the hard metal concentration in the last overlay.

30. The method of claim 25, wherein the steps of applying a first overlay, an intermediate overlay, and a last overlay, include providing successively larger concentrations of hard metal particles with each successive overlay.

31. The method of claim 25, wherein the steps of applying a first overlay, an intermediate overlay, and a last overlay, include providing hard metal particles within the first overlay that are substantially smaller than the hard metal particles applied with the last overlay.

32. The method of claim 26, further comprising the step of selecting a hardness component from the group consisting of: hard metal particles including tungsten carbide, silicon carbide particles, ceramic particles including zirconia and alumina, poly crystalline diamond, amorphous metals, nanocrystalline amorphous metals, nanocrystalline metal, and combinations thereof.

33. The method of claim 25, wherein at least one of the steps of applying an overlay includes applying a mixture of a hardness component and the base metal material, the hardness component providing the hardness component constituency.

34. The method of claim 33, wherein the steps of applying an overlay includes implementing a thermal spray process to apply the overlay.

35. The method of claim 25, wherein the steps of applying an overlay includes applying a mixture of a hardness component and the base metal material, the hardness component providing the hardness component constituencies, whereby the ratio of the hardness component to the base metal material is generally increased in the direction from the interface to the external surface.

36. The method of claim 25, wherein the metallic substrate is made of a metallic substrate material, and wherein the step of applying the first overlay includes applying metallic substrate material as the base metal material.

37. The method of claim 25, wherein the step of applying an intermediate overlay includes applying with a hardness component constituency provided by a first hardness component, wherein the step of applying a hard surface overlay includes applying with a hardness component and constituency provided by a second hardness component that is distinct from the first hardness component.

38. The method of claim 37, wherein at least one of the overlays is composed of an alloy.

39. A protective hardcoating system for a metallic substrate of a downhole tool and the like, the metallic substrate generally characterized by at least one mechanical property that is identified as a factor in the promotion of interfacial stresses during tool service, said hardcoating system comprising:
a hardface coating applied onto the substrate for protection of the substrate, the hardface coating including
an interface surface positioned adjacent the substrate and defining an interface therewith,
a hard external surface positioned externally of the interface; and
an internal coating section defined between the interface and the hard external surface, the coating having a value for the identified mechanical property; and
wherein each of a first portion of the coating section positioned immediately adjacent the interface surface and a second portion of the coating section positioned immediately adjacent the external surface has a composition including a predetermined hardness component constituency, the hardness component constituency of the first portion being distinct from the hardness component constituency of the second portion and wherein the hardness component constituency generally increases with thickness from the interface surface to the externals surface.

40. The protective hardcoating system of claim 39, wherein the hardness component constituencies are generally provided by predetermined populations of carbide particles.

41. The protective hardcoating system of claim 39, wherein the difference between a value for the identified mechanical property near the interface and a value for the identified mechanical property of the substrate is substantially less than the difference between the value for the identified mechanical property of the substrate and the value for the identified mechanical property near the external surface.

42. The protective hardcoating system of claim 39, wherein the identified mechanical property is thermal coefficient of expansion, and wherein the difference between the thermal coefficient of the interface and the thermal coefficient of the substrate is substantially less than the difference between the thermal coefficient of the substrate and the thermal coefficient of the external surface.

43. The protective hardcoating system of claim 39, wherein the internal coating section is composed of a mixture of a hardness component and a base metal material, and wherein the concentration of hardness component generally increases in the direction from the interface surface and the external surface.

44. The protective hardcoating system of claim 43, wherein the metallic substrate is made of a metallic substrate material, and wherein the internal coating includes metallic substrate material applied as the base material.

45. A method of applying a protective hardface coating on a downhole tool element and the like, so as to protect the element from wear during operation, the method comprising the steps of:
identifying a mechanical property of the metallic substrate and the hardface coating;
selecting a metallic substrate of the downhole tool element and the like, for application of the coating;
applying a first overlay over the substrate, the first overlay being composed of a hardness component constituency and a metal base material;
applying at least one intermediate overlay after the first overlay, the intermediate overlay being composed of a hardness component constituency and a metal base material; and
applying a last overlay after the intermediate overlay, the last overlay being composed of a hardness component constituency and a metal base material, whereby the last overlay has a hardness that is substantially greater than the hardness of the first overlay and a value of the identified mechanical property that is less than the value of the identified mechanical property for the first overlay, such that the difference between the values of the identified mechanical property for the substrate and for the first overlay is substantially less than the difference between the values of the identified mechanical property for the last overlay and for the substrate and whereby the intermediate overlay has a value for the identified mechanical property that is less than the value for the first overlay and greater than the value for the last overlay.

46. The method of claim 45, wherein the steps of applying the overlays include selecting metallic substrate material as the metal base material for the first and at least one intermediate overlay, and generally decreasing the amount of metal base material after application of the first overlay.
